(19) United States
(12) Patent Application Publication
(10) Pub. No.: US 2019/0086889 A1
(43) Pub. Date: Mar. 21, 2019

(54) DISTRIBUTIVELY CONTROLLED OPERATING DEVICE SYSTEM

(71) Applicant: Price Industries Limited, Manitoba (CA)

(72) Inventors: Julian Rimmer, London (GB); Jordan Hiebert, London (GB); Sarah Alice Ratcliffe, London (GB); Philipp Friedrich Everding, London (GB); Ainslie Rimmer, London (GB)

(21) Appl. No.: 16/137,993

(22) Filed: Sep. 21, 2018

Related U.S. Application Data
(60) Provisional application No. 62/561,376, filed on Sep. 21, 2017.

(51) Int. Cl. G05B 19/042; F24F 11/63; H05B 33/08

(52) U.S. Cl. CPC G05B 19/042; F24F 11/63; G05B 2219/2642; G05B 2219/2614; H05B 33/0842

(57) ABSTRACT

A distributively controlled operating device system a network with operating devices, and control devices. The operating devices and control devices are connected to the network and are assigned to virtual zones within a building. The operating devices are programmed with a set of scenarios for controlling various physical attributes of the building such as lighting and HVAC. Manual interfaces and multi-sensors are connected to the network and provide zone-tagged inputs to the operating devices. Based on the zone-tagged sensor inputs, the operating device implements one of the programmed scenarios. The virtual zones can be reconfigured by reassigning individual operating devices and control devices to such redefined virtual zones.

### CLAIM OF PRIORITY

The present application claims priority from the U.S. Provisional Patent Application No. 62/561,376, filed on Sep. 21, 2017, the disclosure of which is relied upon and incorporated herein in its entirety by reference.

### FIELD OF THE INVENTION

This invention relates to a distributively controlled operating device system, and more particularly to a distributively controlled operating device system that controls lighting and heating, ventilation, and air-conditioning (HVAC), and other building services within virtual zones of a building.

### BACKGROUND OF THE INVENTION

A typical lighting and HVAC system within a commercial building is controlled by a central control system that communicates with individual physical lighting and HVAC units within the building. Such a system lacks flexibility both in terms of operation, for example, based on ambient lighting available in different physical zones and external and internal heat loading and occupancy conditions. In addition, when the interior space of a commercial building is physically reconfigured to accommodate different uses, a central lighting system and central HVAC system typically have to be rewired in order to accommodate such physical reconfiguration of the lighting and HVAC zones.

### SUMMARY OF THE INVENTION

The present invention addresses the problem associated with the prior art central control of building services within a commercial building. The distributively controlled operating device system of the present invention includes a network and a plurality of control devices and operating devices, each with an integral control system, connected to the network or to network segments. The control devices include user input devices and multisensors. The user input devices may include, without limitation, wall light switches, thermostats, and audio controls. The multisensors may include, without limitation, sensors for occupancy, ambient light, sun shade positions, fire, and temperature. The operating devices may include, without limitation lighting drivers, HVAC units, sprinkler systems, signage, speakers, and other network connected operating devices that can be connected to and controlled over a network. For purposes of illustration without intending to limit the scope of the invention, the disclosure herein is directed to wall switches, multisensors, lighting drivers, and HVAC units. Each of the control devices and operating devices are physically connected to the network and assigned to a virtual zone. The outputs from the control devices are tagged with an identification of the virtual zone to which the control device is assigned. The zone-tagged outputs of the control devices are connected via the network to the inputs of the operating devices in the same zone as the control device. The network protocols may include for example BACnet, MS/TP, or DALI protocols.

Each operating device has its own programmed integral control system that is programmed with various operating scenarios. Each of the various operating scenarios controls the operation of the operating device to produce a particular physical attribute, such as dimming lights or turning on an HVAC unit. The operating scenarios are selected and implemented in response to zone-tagged inputs from control devices on the network. Because the number of scenarios can be set at the time of commissioning or reconfiguration, the computer capability of the integral control system of each operating device can be tailored to match the computing power needed for the number of scenarios assigned to a particular operating device.

The distributively controlled operating device system provides for a plurality of virtual zones within the building. Each zone includes assigned control devices, including multi-sensors and user input devices, assigned lighting drivers, assigned HVAC units, and other operating devices. The lighting in the virtual zones is controlled by the programmed lighting drivers assigned to that virtual zone based on zone-tagged inputs from control devices assigned to that virtual zone. Likewise, the air distribution in the virtual zones is provided by the programmed HVAC units assigned to that virtual zone based on zone-tagged inputs from control devices assigned to that virtual zone.

In such a distributively controlled operating device system, each individual lighting driver determines command scenarios based on the lighting driver's programming and executes appropriate output to control the lighting within the assigned virtual zone. Likewise, each individual HVAC unit determines command scenarios based on the HVAC unit's programming and executes appropriate output to control the air distribution within the assigned virtual zone. Command scenarios stored within the control system of each of the lighting drivers and HVAC units may include, for example, time and date information for identifying weekend and holiday lighting schedules. No master control system is needed although the individual lighting drivers and individual HVAC units can be configured to communicate with a central control system as necessary for central monitoring.

The distributively controlled lighting system uses light emitting diode (LED) lights. Consequently, the control system of the lighting drivers of the distributively controlled lighting system can be programmed to produce lighting scenarios of various colors and to produce varying levels of brightness. Further, because the LED lights are associated individually with a virtual zone, the lighting drivers can individually control multiple LED lights within the virtual zone. In addition, the individual lighting drivers can constantly control and vary the brightness of the LED lights for example over the life of the LED lights, typically increasing drive current as the LED lights age.

In order to save costs, slave lighting drivers may be employed. The individual lighting drivers communicate with and control the slave lighting drivers using 0-10 volts DC control from each individual lighting driver.

Each of the lighting drivers of the distributively controlled lighting system can be factory-programmed to the building's specifications greatly reducing commissioning time. Unlike legacy central lighting systems, a virtual zone is not limited in the number of lighting drivers employed.

Similarly, the HVAC units can be programmed for a set of scenarios to vary temperature and air flow to accommodate the particular occupied physical space included in the virtual zone. The HVAC units can be factory-programmed to the building's specification to reduce commissioning time. Further, unlike legacy central HVAC system, a virtual zone is not limited to a single HVAC unit but can incorporate multiple HVAC units to accommodate variations in the physical space included in the virtual zone.

The distributively controlled operating device system is readily reconfigured to accommodate changes in the building's configuration or usage. In order to reconfigure the distributively controlled operating device system, a temporary controller, such as a personal computer (PC) or tablet, is connected to the network via a network switch. The temporary controller can then issue program instructions to each of the lighting drivers and/or HVAC units to thereby reassign the lighting drivers and/or HVAC units to different zones or to provide revised program instructions for the operating scenarios of each of the lighting drivers and/or HVAC units. Such a reconfiguration eliminates the need to physically rewire any of the user input devices, the multisensors, the lighting drivers, the HVAC units, the LED lights, other control devices, or other operating devices. Once the reconfiguration is complete, the temporary controller is simply removed from the network, and the user input devices, the multisensors, lighting drivers, the HVAC units, the LED lights, other control devices, and other operating devices distributively take over the operation of the network and connected devices.

Further objects, features and advantages will become apparent upon consideration of the following detailed description of the invention when taken in conjunction with the drawings and the appended claims.

### BRIEF DESCRIPTION OF THE DRAWINGS

FIG. 1 is a block diagram showing a first embodiment of the layout of a distributively controlled operating device system in accordance with the present invention.

FIG. 2 is a block diagram showing a second embodiment of the layout of a distributively controlled operating device system in accordance with the present invention.

FIG. 3 is a block diagram showing a third embodiment of the layout of a distributively controlled operating device system in accordance with the present invention.

### DETAILED DESCRIPTION OF THE VARIOUS EMBODIMENTS

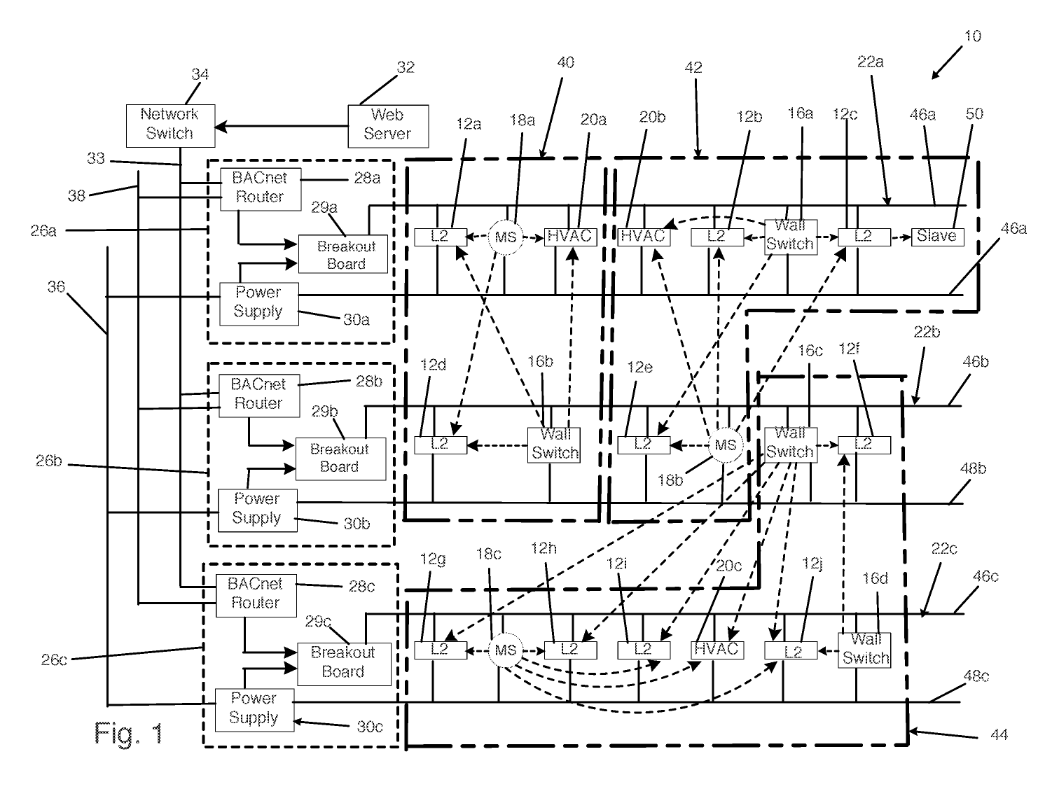

FIGS. 1, 2, and 3 disclose three embodiments of distributively controlled operating device systems 10, 110, and 210, particularly distributively controlled lighting and HVAC systems. Turning to FIG. 1, the distributively controlled operating device system 10 for controlling the lighting and air conditioning in a building includes three network segments 22a, 22b, and 22c. Each of the network segments 22a, 22b, and 22c include network communication lines 46a, 46b, and 46c respectively and network power lines 48a, 48b, and 48c respectively. The network communication lines 46a, 46b, and 46c and the network power lines 48a, 48b, and 48c of networks segments 22a, 22b, and 22c are connected to the building's line voltage 36 and are also connected to the building's BACnet network 38 by means of building nodes 26a, 26b, and 26c. The building nodes 26a, 26b, and 26c include BACnet node routers 28a, 28b, and 28c, node power supplies 30a, 30b, and 30c, and breakout boards 29a, 29b, and 29c. The BACnet node routers 28a, 28b, and 28c and the power supplies 30a, 30b, and 30c are connected to the network segment communication lines 46a, 46b, and 46c through the breakout boards 29a, 29b, and 29c. The power supplies 30a, 30b, and 30c are connected to the network power lines 48a, 48b, and 48c of the network segments 22a, 22b, and 22c. The network communication lines 46a, 46b, and 46c are low power buses that include the BACnet signals and thereby deliver control signals to the network devices. The network power lines 48a, 48b, and 48c are high-power buses that deliver power to the various network devices.

The network segment 22a includes physically connected lighting drivers 12a, 12b, and 12c, multisensor 18a, wall switch 16a, and HVAC units 20a and 20b. The network segment 22b includes physically connected lighting drivers 12d, 12e, and 12f, multisensor 18b, and wall switches 16b and 16c. The network segment 22c includes physically connected lighting drivers 12g, 12h, 12i, and 12j, multisensor 18c, wall switch 16d, and HVAC unit 20c.

The wall switches 16a, 16b, 16c, and 16d include any manually controlled device that provides input from a user to the network segments 22a, 22b, and 22c. For example, the wall switch 16b can set the status for lighting in zone 40 and can broadcast that setting over the network. Because the wall switch 16b is assigned to zone 40, the wall switch 16b broadcasts the light setting with a zone tag that identifies the wall switch 16b as belonging to zone 40. Although the light setting from wall switch 16b is available to every device on the network, only those lighting drivers 12a and 12d recognize that because of the transmitted zone tag the light setting from wall switch 16b is directed to those lighting drivers 12a and 12d in zone 40. Based on light setting from switch 16b, each of the lighting drivers 12a and 12d selects and implements a program scenario from its set of programmed scenarios and controls the associated LED lights accordingly. Similarly, the multisensor 18a assigned to zone 40 broadcasts sensor information with its zone tag to all the devices on the network. Only the lighting drivers 12a and 12d and the HVAC unit 20a use the zone-tagged sensor information from the multisensory 18a to select and implement one of the programmed scenarios in drivers 12a and 12d and the HVAC unit 20a.

The multisensors, for example, detect and broadcast zone-tagged signals relating to occupancy, room temperatures, external heat load, window shade position, light values, and other parameters relating to the environment in the assigned zone. Wall mounted sensors detect user input and broadcast zone-tagged temperatures set points, light selection information, audio selection information, and other user input parameters over the network. For example, the HVAC units receive room temperatures from the multisensors and temperature set points from the wall switches. Lighting drivers receive occupancy and light values from the multisensors and light selection information from the wall switches or other user interface such as a personal computer or tablet. Based on the tagged information broadcast over the network, the light drivers and the HVAC units can select one of the programmed scenarios and control the operating devices accordingly.

The distributively controlled operating device system 10 in FIG. 1 is divided into three zones 40, 42, and 44. Within each zone 40, 42 and 44, arrows with dash lines show the virtual connections between the various components within the zone. For example, in zone 40, the multisensor 18a is physically connected to network segment 22a and provides zone-tagged inputs to lighting driver 12a, to HVAC unit 20a, and to lighting driver 12d. Similarly, the wall switch 16b is physically connected to network segment 22b and provides zone-tagged inputs to the light driver 12d, to light driver 12a, and to HVAC unit 20a. Similar virtual connections illustrated by arrows with dash lines are shown for zone 42 and 44 in FIG. 1. Because the virtual connections can be made between and among different devices, the zones can be configured and reconfigured in a variety of ways depending on the physical configuration and usage of the building.

In addition, an optional Web server 32, with an associated network switch 34 and connection line 33, is connected to the BACnet routers 28a, 28b, and 28c and serves as a central monitoring and control for the operating device system 10. The Web server 32 can be used when connected through network switch 34 to reconfigure the distributively controlled operating device system 10 by reprogramming the lighting drivers and the HVAC units with different scenarios including fewer scenarios or more scenarios. In addition, the light drivers and HVAC units can be reassigned to different zones by reprogramming the lighting drivers or HVAC units. Such reprogramming and resulting reconfiguration of the zones allows the zones to match the physical layout of a building that has been physically reconfigured or the use of which has been changed. The Web server 32, in addition to reprogramming the system components also allows central monitoring of the distributively controlled operating device system, for example, to provide security and to collect performance metrics.

In addition and in order to save costs, slave lighting drivers, such as slave 50 in FIG. 1, may be employed. The individual lighting drivers, such as lighting driver 12c, communicate with and control the slave lighting drivers, such as slave lighting driver 50, using 0-10v DC control from each individual lighting driver.

Unlike prior art distributively controlled operating device systems, the distributively controlled operating device system of the present invention, has no maximum number of operating devices in the system, thereby greatly increasing system flexibility. Such flexibility allows for a virtually limitless number of possible lighting configurations. That flexibility results from the configuration of the control systems in each of the operating devices. Particularly, each operating device is programmed with a set of scenarios. Each scenario when implemented controls the operation of the device. For example, a lighting driver may have separate scenarios for daylight with occupancy, night with occupancy, and no occupancy. The multisensor senses the ambient light and occupancy of zone, and the lighting driver selects one of its three scenarios based on the zone-tagged sensor inputs. Because a particular lighting driver has a set number of scenarios, the amount of computing power installed in that particular lighting driver can be matched to the number of scenarios. Therefore, the amount of computing power and therefore the amount of power required for the network can be matched to the installed scenarios thereby limiting the amount of necessary power and computer power required for the operating devices and resulting in larger number of operating devices on the network.

Again, because of the set number of scenarios required for operation of the building, the operating devices can be factory programmed based on the scenario specifications provided by the building designers prior to installation of the distributively controlled operating device system. With the operating devices factory preprogrammed, installation is accomplished by wiring the network segments such as 22a, 22b, and 22c

Finally, the distributively controlled operating device system 10 of the present invention provides high reliability and ease of maintenance. Failures will be confined to a single driver, sensor, or operating device rather than a central control system. Moreover, isolating and diagnosing failures will be simplified with the configuration of the distributively controlled operating device system 10. For example, any software failure in any of the operating devices or control devices in a zone will affect the performance of the entire zone and therefore isolate the problem to the operating devices or control devices in that particular zone. In other words, if the lighting driver 12a stops processing scenarios, the lights in the zone 40 will go out and the problem can be isolated to zone 40. A hardware failure in an operating device or a control device in a zone will result in the failure of the network segment thereby isolating the problem to the network segment.

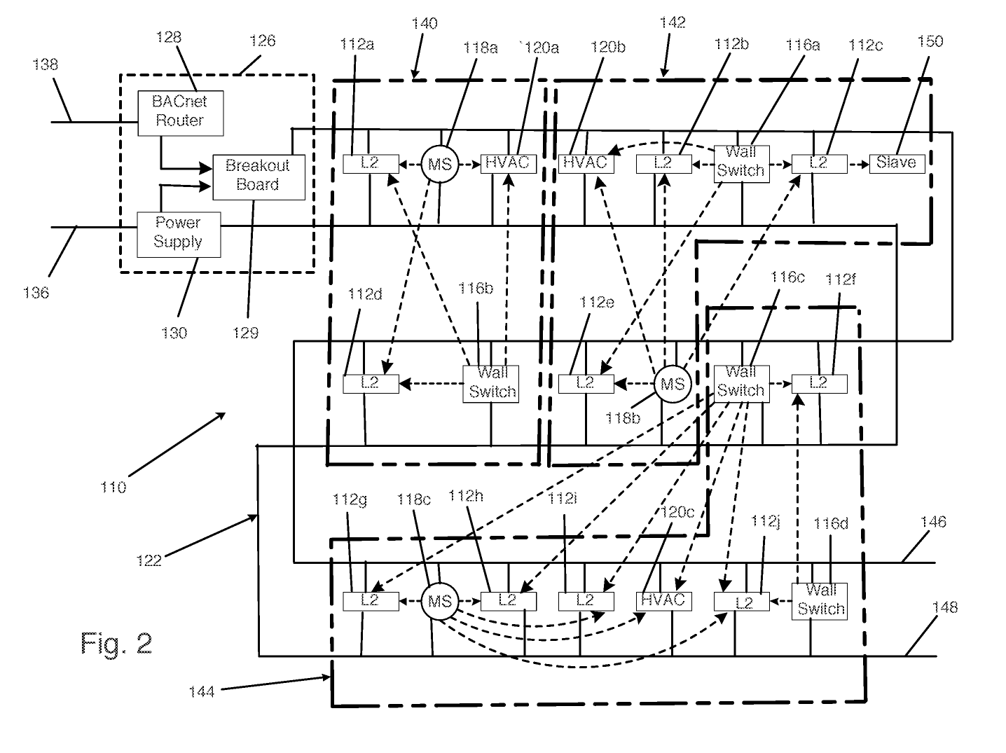

Turning to FIG. 2, a second embodiment of a distributively controlled operating device system 110 is implemented by a single network segment 122. The network segment 122 includes network communication line 146 and network power line 148. The network communication line 146 and the network power line 148 of network segment 122 are connected to the building's line voltage 136 and building's BACnet network 138 by means of a building node 126. The building node 126 includes BACnet node router 128, node power supply 130, and breakout board 129. The BACnet node router 128 and the power supply 130 are connected to the network communication line 146 through the breakout board 129. The power supply 130 is connected to the network power line 148 of the network segment 122. For the single network segment 122, the BACnet over IP network 128 and the BACnet router 128 are optional so that the network segment 122 can operate as a standalone network.

The network segment 122 includes physically connected lighting drivers 12a, 12b, 12c, 12d, 12e, 12f, 12g, 12h, 12i, and 12j, multisensors 18a, 18b, and 18c, wall switches 16a, 16b, 16c, and 16d and HVAC units 20a, 20b, and 20c.

The distributively controlled operating device system 110 in FIG. 2 is divided into three zones 140, 142, and 144. Within each zone 140, 142 and 144, arrows with dash lines show the virtual connections between the various components within each zone. For example, in zone 142, the multisensor 118b provides zone-tagged inputs to lighting drivers 112b, 112c, and 112e and to HVAC unit 120b. Similarly, in zone 142 the wall switch 116a provides zone-tagged inputs to the light drivers 112b, 112c, and 112e and to HVAC unit 120b.

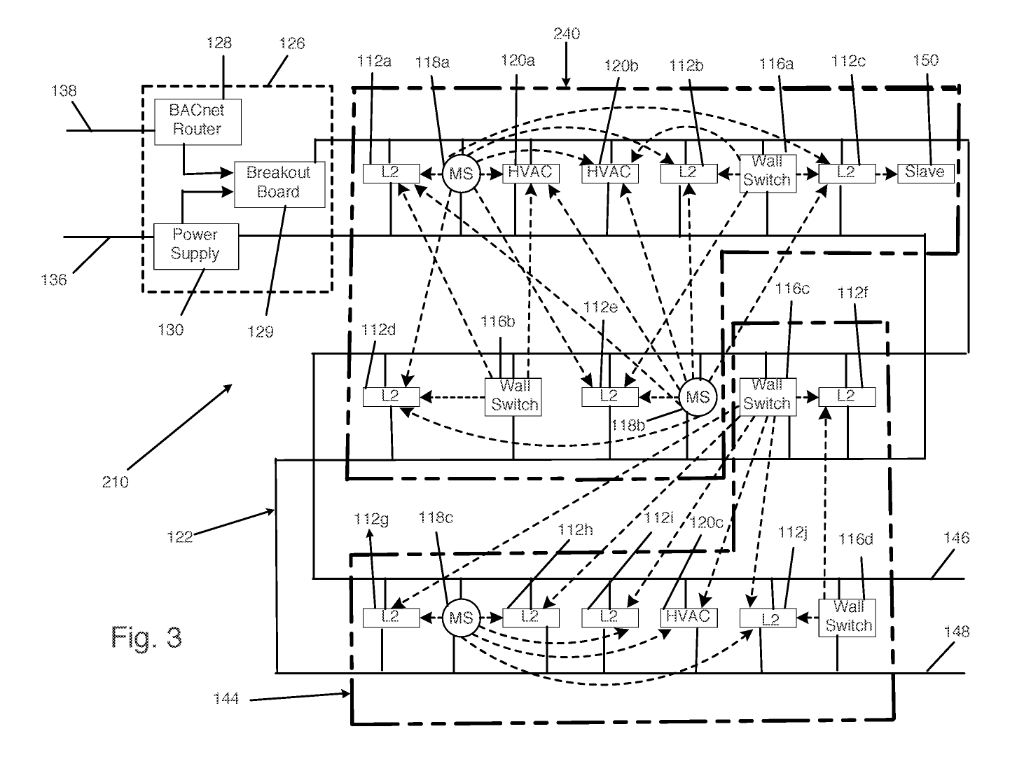

Turning to FIG. 3, FIG. 3 illustrates the reconfiguration of the distributively controlled operating device system 110 shown in FIG. 2 from a three zone system with zones 140, 142, and 144 into a two zone distributively controlled operating device system 210 with zones 240 and 144. Particularly, zones 140 and 142 of FIG. 2 are combined to form the single zone 240 of FIG. 3. Again, the arrows with dash lines show the virtual connections between the components in the zones. Particular, in combined zone 240, both multisensors 118a and 118b provide zone-tagged inputs to lighting drivers 112a, 112b, 112c, 112d, and 112e and to HVAC units 120a and 120b. Wall switch 116a provides zone-tagged inputs to HVAC 120b and to light drivers 112b, 112c, and 112e. Wall switch 116b provides zone-tagged inputs to HVAC 120a and to light drivers 112a and 112d.

While this invention has been described with reference to preferred embodiments thereof, it is to be understood that variations and modifications can be affected within the spirit and scope of the invention as described herein and as described in the appended claims.

I claim:

1. A distributively controlled system comprising:
a. a network;
b. a plurality of virtual zones of the network;
c. a plurality of control devices connected to the network and each control device assigned to one of the virtual zones, each control device in response to environmental parameters associated with the zone produces a zone-tagged output on the network; and
d. a plurality of operating devices connected to the network and each operating device assigned to one of the virtual zones, wherein each operating device includes at least one programmed scenario for controlling a physical attribute and wherein each operating device receives the zone tag output and selects and implements one of the program scenarios to control the physical attribute.

2. The distributively controlled system of claim 1, wherein the operating devices include lighting units.

3. The distributively controlled system of claim 1, wherein the operating devices include heating ventilation and air-conditioning units.

4. The control system of claim 1, wherein the control devices include manually configured control devices, including wall switches or thermostats.

5. The control system of claim 1, wherein the control devices include light sensors, occupancy sensors, temperature sensors, fire sensors, or window shade sensors.

6. The control system of claim 1, wherein the control system further includes slave devices connected to and controlled by the operating devices.
